(19) United States
(12) Patent Application Publication
(10) Pub. No.: US 2014/0260126 A1
(43) Pub. Date: Sep. 18, 2014

(54) Hoof Bandage

(71) Applicant: HOOFSKINS, LLC, Auburn, NY (US)

(72) Inventors: Florence Riley, Auburn, NY (US); Adam Steigerwald, Auburn, NY (US)

(73) Assignee: HOOFSKINS, LLC, Auburn, NY (US)

(21) Appl. No.: 13/799,817

(22) Filed: Mar. 13, 2013

(51) Int. Cl. A01L 15/00

(52) U.S. Cl. CPC A01L 15/00
USPC 54/82

(57) ABSTRACT

The hoof bandage is designed to bandage a hoofed animal's hoof. The hoof bandage includes a base plate with a bottom and at least a front wall portion and a securing element to maintain the base plate on the hoof. The hoof bandage is preferably designed to fit a horse hoof or a cow hoof. The hoof bandage preferably easily slips onto the animal's hoof and is preferably secured by the use of a common household hair dryer to heat the shrink wrap surrounding the animal's hoof. No heating is required in the heel area, as this portion of the hoof is secured with an elastomeric band. Bandaging the hoof is accomplished easily and with less time and considerably fewer problems than with conventional hoof bandaging methods.

### BACKGROUND OF THE INVENTION

1. Field of the Invention

The invention pertains to the field of the treatment of hoofed animals. More particularly, the invention pertains to hoof bandages for hoofed animals.

2. Description of Related Art

When a horse or cattle sustain a hoof injury, it is difficult to effectively bandage the area and treat the animal to minimize the negative effects of the injury.

While there are products for horses that try to fill the need for a bandage, the existing horse boots on the market are cumbersome and bulky, and make it extremely difficult for the farrier or veterinarian to administer medication to the area. They also tend to cause rubbing or irritation in the heel area of the hoof. One example of a horse boot is the Easyboot® horse boot (EasyCare, Inc., Tucson, Ariz.).

Another type of bandage currently being used is self-adhering flexible bandage tape. The flexible bandage tape is not very sturdy, can get wet, can wear through, and eventually falls off. Also, in order to use the flexible bandage tapes (for example, Vetrap® bandaging tape, 3M Company, St. Paul, Minn.), the father or veterinarian must hold the horse's hoof up in order to wrap and bandage it, as well as when administering medication. This is time consuming, and causes stress for the horse. This is particularly problematic when a horse needs hoof packing and/or medication on its hoof every night, for example horses that are raced on a racetrack.

The Hoof Wraps Brand™ equine hoof bandage (Mossy Creek, LLC, Maryville, Tenn.) is a bandage with multiple tabs that is wrapped around the hoof. It requires the use of some kind of flexible bandage tape. The pad at the bottom of the bandage adds half an inch or more of height to the injured hoof, making the horse unbalanced and hindering walking or running.

There is a need in the art for a simple, lightweight, disposable, inexpensive, easy to use, comfortable bandage for a horse or cow's hoof.

### SUMMARY OF THE INVENTION

The hoof bandage is designed to bandage a hoofed animal's hoof. The hoof bandage includes a base plate with a bottom and at least a front wall portion and a securing element to maintain the base plate on the hoof. The hoof bandage is preferably designed to fit a horse hoof or a cow hoof. The hoof bandage preferably easily slips onto the animal's hoof and is preferably secured by the use of a common household hair dryer to heat the shrink wrap surrounding the animal's hoof. No heating is required in the heel area, as this portion of the hoof is secured with an elastomeric band. Bandaging the hoof is accomplished easily and with less time and considerably fewer problems than with conventional hoof bandaging methods.

### BRIEF DESCRIPTION OF THE DRAWINGS

FIG. 1A shows a side view of an equine hoof bandage in an embodiment of the present invention.

FIG. 1B shows a top down view of the equine hoof bandage of FIG. 1A.

FIG. 2A shows a top down view of the base plate of the hoof bandage of FIG. 1A.

FIG. 2B shows a front view of the base plate of the hoof bandage of FIG. 1A.

FIG. 2C shows a side view of the base plate of the hoof bandage of FIG. 1A.

FIG. 2D shows a bottom view of the base plate of the hoof bandage of FIG. 1A.

FIG. 2E shows the shrink wrap of the hoof bandage of FIG. 1A.

FIG. 2F shows the band of the hoof bandage of FIG. 1A.

FIG. 2G shows a top down view of the hoof bandage of FIG. 1A without the band.

FIG. 2H shows a top down view of the hoof bandage of FIG. 1A without the shrink wrap.

FIG. 3A shows a side view of an equine hoof bandage in another embodiment of the present invention.

FIG. 3B shows a top down view of the equine hoof bandage of FIG. 3A.

FIG. 4 shows a side view of an equine hoof bandage in another embodiment of the present invention.

FIG. 5 shows the band of the hoof bandage of FIG. 4.

FIG. 6A shows a side view of an equine hoof bandage in another embodiment of the present invention.

FIG. 6B shows a top down view of the equine hoof bandage of FIG. 6A.

FIG. 7A shows a top down view of the base plate of the hoof bandage of FIG. 6A.

FIG. 7B shows a front view of the base plate of the hoof bandage of FIG. 6A.

FIG. 7C shows a side view of the base plate of the hoof bandage of FIG. 6A.

FIG. 7D shows the shrink wrap of the hoof bandage of FIG. 6A.

FIG. 7E shows the band of the hoof bandage of FIG. 6A.

FIG. 7F shows a top down view of the hoof bandage of FIG. 6A without the band.

FIG. 8A shows a side view of an equine hoof bandage in another embodiment of the present invention.

FIG. 8B shows a top down view of the equine hoof bandage of FIG. 8A.

FIG. 9A shows a side view of an equine hoof bandage in another embodiment of the present invention.

FIG. 9B shows a top down view of the equine hoof bandage of FIG. 9A.

FIG. 10A shows a side view of a bovine hoof bandage in another embodiment of the present invention.

FIG. 10B shows a top down view of the hoof bandage of FIG. 10A.

FIG. 11A shows a top down view of the base plate of the hoof bandage of FIG. 10A.

FIG. 11B shows a front view of the hoof bandage of FIG. 10A.

FIG. 11C shows a side view of the hoof bandage of FIG. 10A.

FIG. 11D shows the bottom of the hoof bandage of FIG. 10A.

FIG. 11E shows a top down view of the hoof bandage with the base plate and the shrink wrap.

FIG. 11F shows a top down view of the hoof bandage with the base plate and the band.

FIG. 12A shows a side view of a bovine hoof bandage in another embodiment of the present invention.

FIG. 12B shows a top down view of the hoof bandage of FIG. 12A.

FIG. 13 shows a side view of a bovine hoof bandage in another embodiment of the present invention.

FIG. 14A shows a side view of a bovine hoof bandage in another embodiment of the present invention.

FIG. 14B shows a top down view of the equine hoof bandage of FIG. 14A.

FIG. 15A shows a top down view of the base plate of the hoof bandage of FIG. 14A.

FIG. 15B shows a front view of the base plate of the hoof bandage of FIG. 14A.

FIG. 15C shows a side view of the base plate of the hoof bandage of FIG. 14A.

FIG. 15D shows a top down view of the hoof bandage of FIG. 14A without the band.

FIG. 16A shows a side view of a bovine hoof bandage in another embodiment of the present invention.

FIG. 16B shows a top down view of the bovine hoof bandage of FIG. 16A.

FIG. 17A shows a side view of a bovine hoof bandage in another embodiment of the present invention.

FIG. 17B shows a top down view of the bovine hoof bandage of FIG. 17A.

The drawings are not necessarily drawn to scale.

### DETAILED DESCRIPTION OF THE INVENTION

The hoof bandages described herein are preferably for use in the agricultural/equine industry and are designed to bandage a hoofed animal's hoof. The hoof bandage preferably easily slips onto the animal's hoof and is preferably secured by the use of a common household hair dryer heating the shrink film surrounding the animal's hoof. No heating is required in the heel area, as this portion of the hoof is secured with an elastomeric band. Bandaging the hoof is accomplished easily and with less time and considerably fewer problems than with conventional hoof bandaging methods. The hoof bandage is easily disposed of after use.

The hoof bandage includes at least one securing element, but the hoof bandage is preferably applied without the use of wrap tapes, adhesive tapes, or glues. The hoof bandage is easily applied over a barefoot hoof or a hoof that is shod. It is extremely lightweight and disposable. Although the hoof bandage is not specifically designed for turnout or riding, horses could have light turnout, because the hoof bandages are sturdy enough to sustain such use, unlike Vetrap® tape, without overly restraining the horse, unlike conventional horse boots.

A hoof bandage is preferably intended for use when the hoofed animal is confined to a stall and medical treatment is being done on the hoof. The hoof bandage is much easier to apply and remove than traditional bandages. Traditional bandages may be applied incorrectly or too tightly so that they restrict blood flow are also difficult to remove. Traditional bandages can soak through with liquid in the stall and may contribute to anaerobic bacteria forming in the hoof with virtually no air supply reaching the affected area. The hoof bandage has a solid bottom but is open in the heel area to permit air flow to the hoof.

The hoof bandages described herein may be used for horses. In these embodiments, the base plate of the hoof bandage is designed to fit the shape of the horse's hooves. The front and side edges of the bottom portion of the base plate preferably follow the shape of the front and side edges of the horse's hoof. The back edge preferably extends substantially straight across from the back of the two side edges under the heel of the hoof. Unlike prior art horse boots, the hoof bandages described herein add minimal height to the animal's hooves. The animal is able to walk or run while using the hoof bandage. In addition, the hoof bandages described herein are easy to take on and off. The hoof bandage also may be left on the hoof for more than one day without detriment to the animal. Once one hoof bandage is removed, another hoof bandage may be applied if a bandage is still needed. The hoof bandages are also easy to remove. The user simply cuts the securing element, which preferably includes a shrink wrap membrane or an elastic band, with a knife, scissors, or other safe cutting device and then removes the hoof bandage from the animal's hoof.

The hoof bandages described herein may also be used for cattle. In these embodiments, the base plate of the hoof bandage is designed to fit the cloven shape of the cow's hooves. The side edges of the bottom portion of the base plate preferably follow the shape of the outer side edges of the cow's claws. The front edge of the bottom portion of the base plate preferably has a convex curved shape following the shape of the front edges of the claws. The back edge preferably extends substantially straight across from the back of the two side edges under the heel of the hoof. The elastic band may also be of a different width to accommodate the different shape of the cow's hoof. In one preferred embodiment, a single hoof bandage is designed in the cloven shape to fit the cow's entire hoof. In another preferred embodiment, two separate hoof bandages may be used, independently or together, each to fit one of the right and left claws of the cow's cloven hoof.

When a cow is being treated, the cow typically comes in a chute. The cow gets lifted up and tipped onto its side. The farrier tips the cow's feet to treat the cow's hooves. The prior art bandages have the same shortcomings for cows as they do for horses, and the hoof bandages described herein make the bandaging process much easier.

In some embodiments, the bottom of the hoof bandage includes a thin treaded pad, which is attached to a solid thin plastic pad, which greatly helps to keep moisture from coming up through the bottom of the hoof, as in conventional wraps, while the horse is in confinement, such as in a stall. Keeping a clay pack or medicinal pack in contact with the hoof while keeping the hoof dry and protected from urine and/or manure is important for a timely recovery.

The hoof bandage is preferably used in the treatment of ailments of hoofed animals' hooves, including, but not limited to, thrush, stone bruises, abscesses, a too close nail injury, and sore soles, as well as for other issues that require a hoof covering, including, but not limited to, clay packing of the hoof.

In preferred embodiments, the hoof bandage described herein includes a base plate, a band portion, and shrink wrap. In other embodiments, the hoof bandage includes a base plate and a band portion. In some embodiments, the base plate includes a bottom, a front, and sides, covering the lower part of the hard portion of the hoof commonly referred to as the hoof walls. In embodiments with sides, the sides are preferably approximately 2-3 inches high. The height of the sides is preferably selected to maximize the support for the animal's hoof, while not reaching past the hairline above the hoof walls. In other embodiments, the base plate includes only a bottom and a front clip. In embodiments with shrink wrap, the shrink wrap is attached to the base plate. In some of these embodiments with shrink wrap, the shrink wrap is also attached to the band portion. In preferred embodiments, the band portion is attached to the base plate, either on the sides or on the front clip portion of the base plate, in embodiments with only a front clip.

The shrink wrap may be any heat shrink film that shrinks in length or width when heat is applied to it. The shrink wrap is preferably a polymer plastic film. In some embodiments, the shrinkable polymer is a polyolefin. Although the shrink wrap preferably shrinks in both length and width (bidirectional), shrink wrap that only shrinks in one direction (unidirectional), length or width, may be used in some embodiments of the present invention. The shrink wrap preferably shrinks without burning when heated with a hair dryer and preferably in the temperature range of about 100 to 150° F.

In some preferred embodiments, the angle of the clip and the band in the back are selected to hold the base plate on until the user shrink wraps the bandage onto the animal's hoof. Generally, every barn already has a hair dryer in it to heat bits before sticking them into horse's mouths.

FIG. 1A through FIG. 2F show an equine hoof bandage 10 with a base plate 12 with a bottom 13 and a front wall portion 14 and side wall portions 15, 16 covering the bases of the hoof walls. The shape of the bottom portion 13 is preferably designed to match the shape of the bottom of a horse hoof. The front 14 and side portions 15, 16 preferably taper in thickness toward the top and angle inward to conform to the shape of the hoof. The angle between the bottom 13 of the base plate 12 and the front 14 is preferably in the range of about 54 to about 60 degrees in this embodiment. The height of the front 14 and side portions 15, 16 is preferably in the range of approximately two to three inches so as not to reach past the hairline. The base plate 12 has a length 22 and a width 24 and includes a tread 26 on the bottom as shown in FIG. 2D.

A band 18 is attached to the outer surfaces of the side portions 15, 16 and extends across the back open portion of the base plate 12. The band 18 has been doubled over by folding the side edges back toward each other to form the crease visible in FIG. 1A and FIG. 1B. This improves the strength of the band 18 and prevents the edges of the band 18 from contacting the hoofed animal. The band 18 is preferably elastic and irreversibly attached to the base plate 12 but may be attached to the base plate 12 by any attachment mechanism, including, but not limited to, an adhesive or a fastener, including, but not limited to a hook-and-loop fastener, a snap, or a button. The band 18 is preferably angled upward from the side portions 15, 16 as shown in FIG. 1A. Shrink wrap 20 covers the entire outer surfaces of the front portion 14 and side portions 15, 16 and extends above these portions toward the front of the hoof bandage 10. The shrink wrap 20 may be attached to any outer surfaces of the base plate 12. The shrink wrap 20 is preferably irreversibly attached to the outer lower edges of the front portion 14 and side portions 15, 16 prior to the hoof bandage 10 being applied to a hoof. Although the shrink wrap 20 is shown as transparent in the drawings, the shrink wrap 20 may alternatively be translucent or opaque within the spirit of the present invention.

To apply the hoof bandage 10 to a hoof, the band 18 is preferably stretched downward and away from the opening back end of the base plate 12. The hoof bandage 10 is then slid over the front of the hoof, with the hoof being inserted through the open top and back portions of the base plate 12. The side portions 15, 16 are preferably flexible so that they may be bent outward during the hoof insertion process. After the bottom of the hoof is in contact with the top surface of the bottom 13 of the base plate 12, the band 18 is raised and released to contact the animal's heel or the back of the animal's lower leg. With the rest of the hoof bandage 10 in place on the hoof, heat is applied to the shrink wrap 20 to shrink the shrink wrap around the base plate 12 and hoof of the animal to complete the application of the hoof bandage 10.

FIG. 2G shows an alternative hoof bandage design. This hoof bandage 110 differs from the hoof bandage 10 of FIG. 1B in that it lacks the band 18. Although this design is not as sturdy as the design of FIG. 1B, it is easier to apply to the hoof and may be sufficiently sturdy for certain situations.

FIG. 2H shows another alternative hoof bandage design. This hoof bandage 210 differs from the hoof bandage 10 of FIG. 1B in that it lacks the shrink wrap 20. Although this design is also not as sturdy as the design of FIG. 1B, it allows easier access to the upper portions of the hoof and may be sufficiently sturdy for certain situations.

The equine hoof bandage 310 of FIG. 3A and FIG. 3B differs from the previous embodiments in that the band 18 has not been doubled over. In this embodiment, the band 18 is attached as a single substantially flat layer of elastic material.

FIG. 4 shows another equine hoof bandage 410 with a band 118 that differs from the band 18 of the previous embodiments. In this embodiment, the band 118 is made of the same material as the previous band 18, but the band is formed as an open cylinder with a hole down the length of the cylinder. A perspective view of the band 118 is shown in FIG. 5. With the ends of the band 118 attached to the base plate 12, there are no ends of the band 118 to contact the hoofed animal.

FIG. 6A through FIG. 7E show an equine hoof bandage 30 with a base plate 32 including a front clip wall portion 34 but no side wall portions. The primary difference between this embodiment and the embodiment shown in FIG. 1A is that the base plate 32 only includes a bottom 33 and a clip portion 34 at the front of the hoof bandage. In one preferred embodiment, the clip portion is approximately 1- 1/4 inches wide by ½ inch tall. The angle between the bottom of the base plate and the clip is preferably in the range of about 54 to about 60 degrees in this embodiment.

Shrink wrap 36 may be attached to any outer surfaces of the base plate 32. The shrink wrap 36 is preferably irreversibly attached to the outer surface of the front portion 34 and the side edges of the bottom 33 of the base plate 32 prior to the hoof bandage 30 being applied to a hoof. The shrink wrap 36 covers the entire outer surface of the clip portion 34 and extends above the bottom 33 and clip portion 34 of the hoof bandage 30. The shrink wrap 36 preferably extends upward from the clip portion 34 at approximately 54 degrees and from the sides of the bottom 33 at approximately 75 degrees. Although the shrink wrap 36 is shown as transparent in the drawings, the shrink wrap 36 may alternatively be translucent or opaque within the spirit of the present invention.

A band 38 is attached to either the inner or outer surfaces of the side portions of the shrink wrap 36 and extends across the back open portion of the base plate 32. The band 38 is preferably elastic and irreversibly attached to the shrink wrap 36 but may be attached to the shrink wrap by any attachment mechanism, including, but not limited to, an adhesive. The band 38 is preferably either horizontal or angled slightly upward with respect to the bottom of the base plate 32 as shown in FIG. 6A.

To apply the hoof bandage 30 to a hoof, the band 38 is preferably stretched downward and away from the back end of the base plate 32. The hoof bandage 30 is then slid over the front of the hoof, with the hoof being inserted through the open top and back portions of the base plate 32. The side portions of the shrink wrap 36 are flexible so that they may be bent outward during the hoof insertion process. After the bottom of the hoof is in contact with the top surface of the bottom 33 of the base plate 32, the band 38 is raised and released to contact the animal's heel or the back of the animal's lower leg. With the rest of the hoof bandage 30 in place on the hoof, heat is applied to the shrink wrap 36 to shrink the shrink wrap 36 around the base plate 32 and hoof of the animal to complete the application of the hoof bandage 30.

FIG. 7F shows an alternative hoof bandage design. This hoof bandage 130 differs from the hoof bandage 30 of FIG. 6B in that it lacks the band 38. Although this design is not as sturdy as the design of FIG. 6B, it is easier to apply to the hoof and may be sufficiently sturdy for certain situations.

FIG. 2F and FIG. 7E show schematics for a band and indicate that the width of the band may vary. Any width for the band may be used that sufficiently holds the animal's heel in place until the shrink wrap has been activated. In some preferred embodiments, the width for the band is approximately in the range of one to three inches. In more preferred embodiments, the width for the band is in the range of approximately two to 2¼ inches.

FIG. 8A and FIG. 8B show an equine hoof bandage 510 with the base plate 12 of FIG. 1A and FIG. 1B. A band 52 loops all the way around the edge of the bottom 13 of the base plate 12 and extends up to cover the entire outer surface of the front portion 14 of the base plate 12. The band 52 preferably extends approximately 2-3 inches above the bottom 13 of the base plate 12 and the width of the band 52 is preferably selected to maximize the support for the animal's hoof, while not reaching past the hairline above the hoof walls. The band 52 may be attached to any outer surfaces of the base plate 12. The band 52 is preferably elastic and irreversibly attached to the outer lower edges of the front portion 14 and side portions 15, 16 prior to the hoof bandage 510 being applied to a hoof. Alternatively the band 52 may only be reversibly stretched over the outer edge of the bottom 13 of the base plate 12. Although the band 52 is shown as opaque in the drawings, the band 52 may alternatively be translucent or transparent within the spirit of the present invention.

To apply the hoof bandage 510 to a hoof, the band 52 is preferably stretched downward and away from the opening back end of the base plate 12. The hoof bandage 510 is then slid over the front of the hoof, with the hoof being inserted through the open top and back portions of the base plate 12. The side portions 15, 16 are preferably flexible so that they may be bent outward during the hoof insertion process. After the bottom of the hoof is in contact with the top surface of the bottom 13 of the base plate 12, the band 52 is raised and released to contact the outer surfaces of the front portion 14 and side portions 15, 16, the front of the animal's hoof above the front portion 14, and the animal's heel or the back of the animal's lower leg. Alternatively, when the band 52 is not attached to the base plate 12, the hoof is first inserted into the base plate 12 and the band 52 is then stretched around the base plate 12 to hold the base plate 12 in position.

FIG. 9A and FIG. 9B show an equine hoof bandage 230 with the base plate 32 of FIG. 6A and FIG. 6B. A band 62 loops all the way around the edge of the bottom 33 of the base plate 32 and extends up to cover the entire outer surface of the clip portion 34 of the base plate 32. The band 62 may be attached to any outer surfaces of the base plate 32. The band 62 is preferably elastic and irreversibly attached to the outer lower edges of the clip portion 34 and bottom 33 of the base plate 32 prior to the hoof bandage 230 being applied to a hoof. Alternatively the band 62 may only be reversibly stretched over the outer edge of the bottom 33 of the base plate 32. Although the band 62 is shown as opaque in the drawings, the band 62 may alternatively be translucent or transparent within the spirit of the present invention.

To apply the hoof bandage 230 to a hoof, the band 62 is preferably stretched downward and away from the opening back end of the base plate 32. The hoof bandage 230 is then slid over the front of the hoof, with the hoof being inserted through the open top and back portions of the base plate 32. After the bottom of the hoof is in contact with the top surface of the bottom 33 of the base plate 32, the band 62 is raised and released to contact the outer surface of the clip portion 34, the front of the animal's hoof above the clip portion 34, the sides of the animal's hoof, and the animal's heel or the back of the animal's lower leg.

In alternative embodiments to FIG. 8A through FIG. 9B, the band may loop most of the way around the base plate but may have two open ends at the front portion of the base plate. In such embodiments with the base plate 32 without sides, the clip portion 34 is preferably higher to prevent the front of the hoof from popping out the front of the hoof bandage.

FIG. 10A through FIG. 11D show a bovine hoof bandage 70 with a base plate 72 with a bottom 73 and a front wall portion 74 and side wall portions 75, 76 covering the bases of the hoof walls. The shape of the bottom portion 13 is preferably designed to match the shape of the bottom of a cow hoof. The front 74 and side portions 75, 76 preferably taper in thickness toward the top and angle inward to conform to the shape of the hoof. An optional wedge 77 extends back from the back of the front portion 74 to insert between the fronts of the two claws when the hoof bandage 70 is applied to the hoof. The wedge 77 only extends back about an inch to aid in aligning the hoof bandage 70 with the hoof and provides added stability to the hoof bandage 70, but in some embodiments, the bovine hoof bandage lacks a wedge. The angle between the bottom 73 of the base plate 72 and the front 74 is preferably in the range of about 54 to about 60 degrees in this embodiment. The height of the front 74 and side portions 75, 76 is preferably in the range of approximately two to three inches so as not to reach past the hairline. The base plate 72 has a length 82 and a width 84 and includes a tread 86 on the bottom as shown in FIG. 11D.

A band 78 is attached to the outer surfaces of the side portions 75, 76 and extends across the back open portion of the base plate 72. The band 78 has been doubled over by folding the side edges back toward each other to form the crease visible in FIG. 10A and FIG. 10B. This improves the strength of the band 78 and prevents the edges of the band 78 from contacting the hoofed animal. The band 78 is preferably elastic and irreversibly attached to the base plate 72 but may be attached to the base plate 72 by any attachment mechanism, including, but not limited to, an adhesive or a fastener, including, but not limited to a hook-and-loop fastener, a snap, or a button. The band 78 is preferably angled upward from the side portions 75, 76 as shown in FIG. 10A. Shrink wrap 80 covers the entire outer surfaces of the front portion 74 and side portions 75, 76 and extends above these portions toward the front of the hoof bandage 70. The shrink wrap 80 may be attached to any outer surfaces of the base plate 72. The shrink wrap 80 is preferably irreversibly attached to the outer lower edges of the front portion 74 and side portions 75, 76 prior to the hoof bandage 70 being applied to a hoof. Although the shrink wrap 80 is shown as transparent in the drawings, the shrink wrap 80 may alternatively be translucent or opaque within the spirit of the present invention.

To apply the hoof bandage 70 to a hoof, the band 78 is preferably stretched downward and away from the opening back end of the base plate 72. The hoof bandage 70 is then slid over the front of the hoof, with the hoof being inserted through the open top and back portions of the base plate 72 and the wedge 77 inserting between the two claws. The side portions 75, 76 are preferably flexible so that they may be bent outward during the hoof insertion process. After the bottom of the hoof is in contact with the top surface of the bottom 73 of the base plate 72, the band 78 is raised and released to contact the animal's heel or the back of the animal's lower leg. With the rest of the hoof bandage 70 in place on the hoof, heat is applied to the shrink wrap 80 to shrink the shrink wrap around the base plate 72 and hoof of the animal to complete the application of the hoof bandage 70.

FIG. 11E shows an alternative hoof bandage design. This hoof bandage 170 differs from the hoof bandage 70 of FIG. 10B in that it lacks the band 78. Although this design is not as sturdy as the design of FIG. 10B, it is easier to apply to the hoof and may be sufficiently sturdy for certain situations.

FIG. 11F shows another alternative hoof bandage design. This hoof bandage 270 differs from the hoof bandage 70 of FIG. 10B in that it lacks the shrink wrap 80. Although this design is also not as sturdy as the design of FIG. 10B, it allows easier access to the upper portions of the hoof and may be sufficiently sturdy for certain situations.

The equine hoof bandage 370 of FIG. 12A and FIG. 12B differs from the previous embodiments in that the band 78 has not been doubled over. In this embodiment, the band 78 is attached as a single substantially flat layer of elastic material.

FIG. 13 shows another bovine hoof bandage 470 with a band 178 that differs from the band 78 of the previous embodiments. In this embodiment, the band 178 is made of the same material as the previous band 78, but the band is formed as an open cylinder with a hole down the length of the cylinder. With the ends of the band 178 attached to the base plate 72, there are no ends of the band 178 to contact the hoofed animal.

FIG. 14A through FIG. 15C show a bovine hoof bandage 90 with a base plate 92 including a front clip wall portion 94 but no side wall portions. The primary difference between this embodiment and the embodiment shown in FIG. 10A is that the base plate 92 only includes a bottom 93 and a clip portion 94 at the front of the hoof bandage. An optional wedge 97 extends back from the back of the front portion 94 to insert between the fronts of the two claws when the hoof bandage 90 is applied to the hoof. The wedge 97 only extends back about an inch to aid in aligning the hoof bandage 90 with the hoof and provides added stability to the hoof bandage 90, but in some embodiments, the bovine hoof bandage lacks a wedge. The bovine clip portion 94 is preferably wider and taller than the equine clip portion 34 to accommodate both claws of the bovine hoof but still smaller than the front portion 74 in the first bovine hoof bandage embodiment. The angle between the bottom of the base plate and the clip is preferably in the range of about 54 to about 60 degrees in this embodiment.

Shrink wrap 96 may be attached to any outer surfaces of the base plate 92. The shrink wrap 96 is preferably irreversibly attached to the outer surface of the front portion 94 and the side edges of the bottom 93 of the base plate 92 prior to the hoof bandage 90 being applied to a hoof. The shrink wrap 96 covers the entire outer surface of the clip portion 94 and extends above the bottom 93 and clip portion 94 of the hoof bandage 90. The shrink wrap 96 preferably extends upward from the clip portion 94 at approximately 54 degrees and from the sides of the bottom 93 at approximately 75 degrees. Although the shrink wrap 96 is shown as transparent in the drawings, the shrink wrap 96 may alternatively be translucent or opaque within the spirit of the present invention.

A band 98 is attached to either the inner or outer surfaces of the side portions of the shrink wrap 96 and extends across the back open portion of the base plate 92. The band 98 is preferably elastic and irreversibly attached to the shrink wrap 96 but may be attached to the shrink wrap by any attachment mechanism, including, but not limited to, an adhesive. The band 98 is preferably either horizontal or angled slightly upward with respect to the bottom of the base plate 92 as shown in FIG. 14A.

To apply the hoof bandage 90 to a hoof, the band 98 is preferably stretched downward and away from the back end of the base plate 92. The hoof bandage 90 is then slid over the front of the hoof, with the hoof being inserted through the open top and back portions of the base plate 92 and the wedge 97 inserting between the two claws. The side portions of the shrink wrap 96 are flexible so that they may be bent outward during the hoof insertion process. After the bottom of the hoof is in contact with the top surface of the bottom 93 of the base plate 92, the band 98 is raised and released to contact the animal's heel or the back of the animal's lower leg. With the rest of the hoof bandage 90 in place on the hoof, heat is applied to the shrink wrap 96 to shrink the shrink wrap 96 around the base plate 92 and hoof of the animal to complete the application of the hoof bandage 90.

FIG. 15D shows an alternative hoof bandage design. This hoof bandage 190 differs from the hoof bandage 90 of FIG. 14B in that it lacks the band 98. Although this design is not as sturdy as the design of FIG. 14B, it is easier to apply to the hoof and may be sufficiently sturdy for certain situations.

Any width for the band may be used that sufficiently holds the animal's heel in place until the shrink wrap has been activated. In some preferred embodiments, the width for the band is approximately in the range of one to three inches. In more preferred embodiments, the width for the band is in the range of approximately two to 2¼ inches.

FIG. 16A and FIG. 16B show a bovine hoof bandage 570 with the base plate 72 of FIG. 10A and FIG. 10B. A band 112 loops all the way around the edge of the bottom 73 of the base plate 72 and extends up to cover the entire outer surface of the front portion 74 of the base plate 72. The band 112 preferably extends approximately 2-3 inches above the bottom 73 of the base plate 72 and the width of the band 112 is preferably selected to maximize the support for the animal's hoof, while not reaching past the hairline above the hoof walls. The band 112 may be attached to any outer surfaces of the base plate 72. The band 112 is preferably elastic and irreversibly attached to the outer lower edges of the front portion 74 and side portions 75, 76 prior to the hoof bandage 570 being applied to a hoof. Alternatively the band 112 may only be reversibly stretched over the outer edge of the bottom 73 of the base plate 72. Although the band 112 is shown as opaque in the drawings, the band 112 may alternatively be translucent or transparent within the spirit of the present invention.

To apply the hoof bandage 570 to a hoof, the band 112 is preferably stretched downward and away from the opening back end of the base plate 72. The hoof bandage 570 is then slid over the front of the hoof, with the hoof being inserted through the open top and back portions of the base plate 72 and the wedge 77 inserting between the two claws. The side portions 75, 76 are preferably flexible so that they may be bent outward during the hoof insertion process. After the bottom of the hoof is in contact with the top surface of the bottom 73 of the base plate 72, the band 112 is raised and released to contact the outer surfaces of the front portion 74 and side portions 75, 76, the front of the animal's hoof above the front portion 74, and the animal's heel or the back of the animal's lower leg. Alternatively, when the band 112 is not attached to the base plate 72, the hoof is first inserted into the base plate 72 and the band 112 is then stretched around the base plate 72 to hold the base plate 72 in position.

FIG. 17A and FIG. 17B show a bovine hoof bandage 290 with the base plate 92 of FIG. 6A and FIG. 6B. A band 122 loops all the way around the edge of the bottom 93 of the base plate 92 and extends up to cover the entire outer surface of the clip portion 94 of the base plate 92. The band 122 may be attached to any outer surfaces of the base plate 92. The band 122 is preferably elastic and irreversibly attached to the outer lower edges of the clip portion 94 and bottom 93 of the base plate 92 prior to the hoof bandage 290 being applied to a hoof. Alternatively the band 122 may only be reversibly stretched over the outer edge of the bottom 93 of the base plate 92. Although the band 122 is shown as opaque in the drawings, the band 122 may alternatively be translucent or transparent within the spirit of the present invention.

To apply the hoof bandage 290 to a hoof, the band 122 is preferably stretched downward and away from the opening back end of the base plate 92. The hoof bandage 290 is then slid over the front of the hoof, with the hoof being inserted through the open top and back portions of the base plate 92 and the wedge 97 inserting between the two claws. After the bottom of the hoof is in contact with the top surface of the bottom 93 of the base plate 92, the band 122 is raised and released to contact the outer surface of the clip portion 94, the front of the animal's hoof above the clip portion 94, the sides of the animal's hoof, and the animal's heel or the back of the animal's lower leg.

In alternative embodiments to FIG. 16A through FIG. 17B, the band may loop most of the way around the base plate but may have two open ends at the front portion of the base plate. In such embodiments with the base plate 92 without sides, the clip portion 94 is preferably higher to prevent the front of the hoof from popping out the front of the hoof bandage.

The equine and bovine hoof bandages are preferably available in a range of sizes. In one preferred embodiment, the equine and bovine hoof bandages are preferably available in at least three sizes, small, medium, and large, for each of the front and hind hooves, for a total of six equine sizes and six bovine sizes, to accommodate different sizes of horses' and cows' hooves. In some preferred embodiments, the equine hoof bandages are also available in pony size and the bovine hoof bandages are also available in calf sizes.

In one preferred embodiment, the approximate sizes of the base plate for the various sizes to accommodate a horse's or cow's hoof, as measured by the length 22, 82 and the width 24, 84 of the bottom of the base plate, as shown in FIG. 2D and FIG. 11D, respectively, are as follows. The pony size is four inches wide by five inches long. The small horse size is five inches wide by six inches long; the regular horse size is five and a half inches wide by six and a quarter inches long; and the large horse size is six inches wide by six and three quarter inches long. The owner preferably chooses the size for the best fit on the horse. However, as a general guideline, the following sizes would correspond to the following shoe size for the horse: 0000, 000, 00, 0, 1, 2, 3.

In one preferred embodiment, the hoof bandage is made in a variety of colors. In another embodiment, the color of the hoof bandage identifies its size or whether it is for a front or hind hoof. In another embodiment, the size, or whether the bandage is for the front (F) or the hind (H) hoof, is stamped into or printed on the top or bottom of the base plate or the band portion.

The bottom of the base plate preferably includes a non-slip or non-skid tread 26, 86 as shown in FIG. 2D and FIG. 11D. The tread may be part of the injection molded plastic product or be separately added after formation of the base plate. In embodiments when the tread is added after the hoof bandage has been produced, the non-slip tread may be a single pad or multiple individual non-slip surfaces added to the bottom of the hoof bandage to create a non-slip surface. The tread is preferably lightweight and reduces slippage of the hoof bandage when the animal stands or moves using the bandaged hoof. The tread may be any pattern selected to provide friction between the bottom of the base plate and the ground, to stabilize the horse's hoof and minimize slipping when the horse is wearing the hoof bandage. Although the tread is visible only in FIG. 2D and FIG. 11D, all embodiments preferably include a tread on the bottom of the base plate.

Many horse owners are inexperienced and do not know how to correctly apply self-adhering bandaging tape. For example, the owner may place the tape too high and too tight, thereby constrict the foot above the hoof and cutting the blood supply, resulting in long term health problems for the animal. In contrast, the hoof bandages described herein are easy to use by anyone. All the user has to do is pick up the foot, put on the medication, put the bandage over the hoof, then shrink the shrink wrap or apply the elastic band to the animal's hoof.

The shrink wrap conforms to the shape of the animal's hoof without cutting off circulation to the hoof. Also, because there is no shrink wrap in the heel, it does not touch the sensitive tissue in the heel. In preferred embodiments, the thickness of the shrink wrap is in the range of approximately 0.5 mil to 3 mil. In one preferred embodiment, the shrink wrap thickness is in the range of approximately 1 mil to 1.2 mil. The shrink percentage may be any percentage that effectively retains the hoof bandage on the animal's hoof. In some preferred embodiments, the shrinkage percentage is in the range of approximately 5% to 35% shrinkage when the shrink wrap is heated. In one preferred embodiment, Cryovac Rollshrink® shrink wrap (Cryovac, Inc., Elmwood Park, N.J.) is used as the shrink wrap. The shrink wrap is chosen so that it can be shrunk with the heat of a conventional hair dryer or a similar tool that provides heat at temperature in the range of about 140 to 150° F. The temperature chosen to activate the shrink wrap is a temperature sufficient to heat the shrink wrap to conform about the hoof of the horse without hurting or burning the animal or the shrink wrap. Tools that generate heat at temperatures above 150° F. may alternatively be used, but care must be taken to not injure the horse while administering heat to the hoof bandage. For example, if a particular hair dryer emits heat at a very high temperature, increasing the distance between the hair dryer and the animal provides the right amount of heat to activate the shrink wrap without injuring the animal.

In preferred embodiments, the band is made of a soft, elastic, elastomeric band, or elastomeric material, such as rubber sheeting or another elastic material. In one preferred embodiment, the band is made of a latex-free material, to minimize the likelihood of irritating the animal's heel, causing an allergic reaction, or creating abrasions when using the hoof bandage. The heel area has extremely sensitive tissue, so it is important to treat that area with care. Only the band touches the heel area of the animal. The level of resistance of the elastic material is chosen to balance keeping the bandage on the animal (until the shrink wrap is heated for the embodiments with shrink wrap) while also minimizing irritation to the heel area. One example of an elastic band material that may be used is Thera-band® rubber sheeting (Hygenic Corporation, Akron, Ohio). In other embodiments, the band material may be latex or nitrile. Any width for the band that sufficiently holds the animal's heel in place until the shrink wrap has been activated. In some preferred embodiments, the width for the band is in the range of approximately 1 to 3 inches. In more preferred embodiments, the width for the band is in the range of approximately 2 to 2¼ inches.

The elastic band holds the hoof bandage on the animal's hoof with a backward and upward force. The shrink wrap holds the hoof bandage on the animal's hoof at the front and sides of the hoof. Since only the band touches the animal's heel, the fact that the band pulls back does not hurt the heel.

The base plate, which in some embodiments includes a bottom, a front, and sides, and in other embodiments only includes a bottom and a front clip portion, is preferably made of a plastic type of material, which is preferably lightweight and inexpensive. The base plate is preferably not made of metal. The base plate is preferably formed by injection molding. In some preferred embodiments, the base plate is made of one or more of the following materials or blends thereof: a vinyl polymer, a vinyl copolymer, an olefin polymer, an olefinic polymer, polyethylene (PE), polypropylene (PP), a copolymer of polyethylene, a copolymer of polypropylene, poly(ethylene vinyl acetate) (PEVA), poly(ethylene acrylic acid) (PEAA), poly(ethylene butyl acrylate) (PEBA), poly(ethylene methacrylic acid) (PEMA), polyester, poly(ethylene terephthalate) (PET), glycol-modified poly(ethylene terephthalate) (PETG), polyester copolymer, and polyurethanes.

In some preferred embodiments, blends of materials, such as blends of plastics, are used. The material of the base plate is preferably selected to balance the following factors: strength, weight, cost, coefficient of friction, toughness, flexibility, and abrasion resistance.

The thickness of the bottom of the base is preferably selected to withstand the animal's weight and use of the hoof by the animal while the hoof bandage is on the hoof, while being sufficiently thin to minimize the height different between the bandaged hoof and the animal's other hooves. In some preferred embodiments, the thickness of the bottom is in the range of approximately 50 mils to ¼ inch. In preferred embodiments, the sides and front are thinner than the bottom. In some preferred embodiments, the side and front walls have a tapered thickness as the sides and front extend upwards from the bottom. In other words, the sides and front get progressively thinner as they extend farther away from the bottom of the base plate. This, combined with an inward angle towards the hoof and the center of the bottom of the hoof bandage, is so that the side and front walls conform to the animal's hoof.

Unlike the hoof boots on the market today, the hoof bandages described herein are not intended for letting the horse go out and be active (“turnout”). Instead, the hoof bandages described herein are preferably intended for use while administering medication to the animal and leaving the animal in the stall (stall rest) until the injury is healed. However, the bandages may be used for light turnout. In some embodiments, a thicker base plate is used to permit turnout of the hoofed animal. In some such embodiments, the thickness of the bottom of the base plate is in the range of ¼ inch to ½ inch.

In preferred embodiments, the hoof bandage includes a base plate, an elastic band, and shrink wrap attached to the base plate. In some embodiments, the base plate includes a bottom, a front, and sides, while in other embodiments, the base plate includes a bottom and only a front clip portion. In other preferred embodiments, the hoof bandages includes a base plate and an elastomeric band. Preferably, in every embodiment, the base plate does not extend up past the wall portion of the hoof. In addition, in embodiments with shrink wrap, the shrink wrap is only located such that it makes contact with the wall portions of the hoof. This means that neither the base plate nor the shrink wrap extends into the sensitive heel portion of the hoof or above the bony hard portion of the front and sides of the hoof. An elastomeric band preferably covers the heel portion.

In some preferred embodiments, the base plate is manufactured by a process including, but not limited to, injection molding, thermoforming, adhesive welding, and hot melt adhesives. The base plate is preferably molded as one piece; however, in other embodiments, one or more of the pieces (bottom, front, sides) of the base plate may be molded in separate pieces and then joined. Some techniques that could be used for joining in these embodiments include, but are not limited to, heat sealing, ultrasonic welding, adhesives, or physical joining.

The base plate preferably has an anti-slip tread on the bottom surface. The tread may be molded in the bottom as part of the base plate mold, for example as part of the injection molding process. Alternatively, the anti-slip tread may be made from a sheet and added to the bottom surface of the base plate after the base plate has been manufactured.

One method of manufacturing a hoof bandage is described here. The base plate is manufactured, as described above. Then, the band is attached to the base plate in embodiments where the base plate includes a front and sides and in embodiments where there is no shrink wrap. Some examples of ways the band could be attached to the base plate include, but are not limited to, adhering the band to the base plate with adhesive, heat sealing the band to the base plate, or mechanically fastening the band to the base plate, for example with rivets, staples, or screws.

The shrink wrap is then attached to the base plate, for example by adhesive or heat sealing. If heat sealing is used, the heat sealing is performed only in certain locations, so that the portion of the shrink wrap that needs to shrink to the animal's hoof remains intact.

The shrink wrap is preferably oriented before it is shrunk. Once the hoof bandage has been applied to an animal, and the shrink wrap shrunk, it is tougher.

In embodiments where the base plate only includes a front clip portion, the band is attached to the shrink wrap. The band may be attached to the shrink wrap in any manner that does not sacrifice the integrity of the shrink wrap or the band, for example, by adhering the band to the base plate with adhesive or heat sealing.

In an alternative method for manufacturing the hoof bandage, the base plate and the band are made together in an in-mold assembly process. In this process, the elastic band is put into the mold itself. The mold includes a space for the elastic band, and the plastic or other material used to make the base plate is molded around it. In these embodiments, the shrink wrap is still adhered to the base plate in a separate step.

As an example of the process with three separate parts, first the base plates are molded with injection molding. The base plates are then transported to a conveyor belt and clamped to keep them still. Hot melt adhesive is applied onto the base plate, and the band is added to the base plate. In a similar step, hot melt adhesive is added to the base plate to add the shrink wrap. In some preferred embodiments of manufacturing, roll shrink wrap is used. The shrink wrap is preferably added at a specific predetermined angle, so the conveyor belt is preferably at the angle need to add the shrink wrap correctly.

In some embodiments, the elastic band is formed with or coupled to the base plate during the formation of the base plate rather than being attached to the base plate as a separate step after formation of the base plate.

Although the hoof bandage is shown and described specifically for horses and cows, by designing the hoof bandage to fit the shape of the hoof, a hoof bandage may be designed for any hoofed animal, including, but not limited to, one-toed hoofed animals, including, but not limited to, donkeys, horses, ponies, rhinoceroses, and zebras, and two-toed cloven hoofed animals, including, but not limited to, antelopes, bison, camels, caribou, cattle, deer, gaurs, gazelles, giraffes, goats, hippopotamuses, impala, moose, pigs, sheep, water buffaloes, and wildebeest.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A hoof bandage comprising:
a) a base plate comprising:
a bottom portion having a front edge, a first side edge, and a second side edge opposite the first side edge following a shape of a hoof of a hoofed animal and a back edge extending substantially straight across from the side edges behind the hoof; and
a wall portion extending up from the front edge of the bottom portion; and
b) at least one securing element coupled to the base plate to maintain the base plate on the hoof of the hoofed animal.

2. The hoof bandage of claim 1, wherein the wall portion further extends back from the front edge along the first side edge and the second side edge of the bottom portion.

3. The hoof bandage of claim 2, wherein the securing element comprises a band having a first band end attached to the wall portion above the first side edge of the base plate and a second band end opposite the first band end attached to the wall portion above the second side edge of the base plate.

4. The hoof bandage of claim 3, wherein the band is elastomeric.

5. The hoof bandage of claim 4, wherein the securing element further comprises a film of shrink wrap attached to an outside surface of the base plate and extending upward above the wall portion of the base plate.

6. The hoof bandage of claim 1, wherein the securing element further comprises a film of shrink wrap attached to an outside surface of the base plate and extending upward above the wall portion of the base plate, a first side edge of the base plate, and a second side edge of the base plate opposite the first side edge.

7. The hoof bandage of claim 1 further comprising a tread on a bottom surface of the bottom portion of the base plate.

8. The hoof bandage of claim 1, wherein the base plate further comprises a wedge extending between a back surface of the wall portion and a top surface of the bottom portion of the base plate, wherein the hoof is a cloven hoof, the wedge being shaped to fit in front between a pair of claws of the cloven hoof.

9. The hoof bandage of claim 1, wherein the securing element comprises a band, wherein the band loops around an outer perimeter of the bottom portion of the base plate and extends upward from the bottom portion past the wall portion.

10. The hoof bandage of claim 9, wherein the band is elastomeric.

11. The hoof bandage of claim 1, wherein a back of the base plate is open with no wall portion extending from the back edge of the bottom portion of the base plate.

12. The hoof bandage of claim 1, wherein the hoofed animal is a horse.

13. The hoof bandage of claim 1, wherein the hoofed animal is a cow.

14. A method of applying a hoof bandage to a hoof of a hoofed animal, the method comprising the steps of:
a) placing the hoof on a base plate of the hoof bandage, the base plate comprising:
a bottom portion having a front edge, a first side edge, and a second side edge opposite the first side edge following a shape of the hoof of the hoofed animal and a back edge extending substantially straight across from the side edges behind the hoof; and
a wall portion extending up from the front edge of the bottom portion; and
b) applying a securing element of the hoof bandage to maintain the base plate on the hoof.

15. The method of claim 14, wherein the wall portion further extends back from the front edge along the first side edge and the second side edge of the bottom portion and the securing element comprises a band having a first band end attached to the wall portion above the first side edge of the base plate and a second band end opposite the first band end attached to the wall portion above the second side edge of the base plate, the method further comprising pulling the band backward and downward and pushing the wall portion above the first side edge and the wall portion above the second side edge apart to provide an opening to permit placement of the hoof on the base plate of the hoof bandage.

16. The method of claim 15, wherein the securing element further comprises a film of shrink wrap attached to an outside surface of the base plate and extending upward above the wall portion of the base plate, step b) further comprising the substep of heating the film of shrink wrap to shrink the film to a shape of the outside surfaces of the base plate and the hoof.

17. The method of claim 13, wherein the securing element further comprises a film of shrink wrap attached to an outside surface of the base plate and extending upward above the wall portion of the base plate, step b) further comprising the substep of heating the film of shrink wrap to shrink the film to a shape of the outside surfaces of the base plate and the hoof.

18. The method of claim 13, wherein the base plate further comprises a wedge extending between a back surface of the wall portion and a top surface of the bottom portion of the base plate, wherein the hoof is a cloven hoof, the wedge being shaped to fit in front between a pair of claws of the cloven hoof, step a) further comprising the substep of inserting the wedge between the pair of claws of the cloven hoof in the front of the hoof.

19. The method of claim 13, wherein the securing element comprises a band, step b) further comprising stretching the band to loop around an outer perimeter of the bottom portion of the base plate.
